(19) United States
(12) Patent Application Publication
(10) Pub. No.: US 2006/0181394 A1
(43) Pub. Date: Aug. 17, 2006

(54) Radio frequency fingerprinting to detect fraudulent radio frequency identification tags

(76) Inventor: James B. Clarke, Broomfield, CO (US)

Correspondence Address: HOGAN & HARTSON LLP, ONE TABOR CENTER, SUITE 1500, 1200 SEVENTEEN ST., DENVER, CO, 80202, US

(21) Appl. No.: 11/045,219

(22) Filed: Jan. 28, 2005

(51) Int. Cl. H04Q 5/22

(52) U.S. Cl. 340/10.4

(57) ABSTRACT

A method of authenticating the identity of an RFID device having a tag identifier stored therein. The tag identifier for the RFID device is recorded along with an RF fingerprint for the RFID device. When the RFID device is interrogated a response is received from the interrogated RFID device. An RF fingerprint is determined form the response and the received response including the RF fingerprint associated with the response is compared to an expected RF fingerprint previously known to be associated with the RFID device being interrogated.

### BACKGROUND OF THE INVENTION

1. Field of the Invention

The present invention relates, in general, to radio frequency identification (RFID) tags, and, more particularly, to techniques, systems and methods for identifying fraudulent RFID tags using radio frequency fingerprinting.

2. Relevant Background

Radio frequency identification (RFID) devices function as identifiers for thins such as consumer goods, hardware assets, paper files, and other material things and assets that are inventoried, stored, and moved in the course of business. RFID devices are implemented as integrated circuits and may be embodied in the form of tags, stickers, labels, or otherwise affixed to or implanted into the materials being tracked. RFID tags are relatively small (some are smaller than a nickel), inexpensive, and do not require a power source. RFID devices report the presence or absence of a tag in their field of sensitivity.

An RFID device comprises circuitry that responds to an interrogating device by sending out a radio frequency signal declaring a unique identification code or serial number assigned to that particular device. The interrogation device receives the broadcast signal and performs some action based on the presence or absence of a response to its interrogation. For example, when an RFID device responds an inventory record can be updated to indicate that the associated product is present in inventory.

The unique code assigned to a particular device is often stored in memory on the integrated circuit. Some RFID devices include writeable memory that allows the identification code stored on one device to be copied or cloned into another device. The cloned RFID device can then be used to masquerade as the true identity of another object. A fraudulent RFID device could be used, for example, to purchase an expensive product by switching the genuine RFID device with a cloned copy of an RFID device from a less expensive product. Further, assets can be removed from inventories undetectably by placing cloned RFID devices in place of the genuine RFID device that is affixed or embedded in the asset. Even when encryption and digital signature techniques are used to protect the identifier in an RFID device, the encrypted information can be copied into a fraudulent RFID device.

Radio frequency fingerprinting (RFF) refers to techniques used to identify the subtle and unique characteristics of radio transmission caused by random production differences between radio frequency devices. RFF involves the detection of unique characteristics of the radio frequency energy of a particular transceiver and has been used for identification of wireless devices such as cell phones. These unique characteristics can be used to create a unique signature, similar to human fingerprints, for a specific transmission device. RFF and applications of RFF are described in “DETECTION OF TRANSIENT IN RADIO FREQUENCY FINGERPRINTING USING SIGNAL PHASE” by J. Hall, M. Barbeau and E. Kranakis (Proceedings of IASTED International Conference on Wireless and Optical Communications, 2003), which is incorporated herein by reference.

Hence, what is needed is a method and an apparatus for authenticating the identity of an RFID device so that interrogating systems can readily distinguish authentic RFID devices from non-authentic RFID devices.

### SUMMARY OF THE INVENTION

Briefly stated, the present invention involves the application of radio frequency fingerprinting to the authentication of RFID devices. The identifier of an RFID tag is associated with a unique RF fingerprint of the device in which the identifier is encoded. Once this associate is made, when an authentic RFID device is interrogated the correct pairing of an identifier with the RF fingerprint is used authenticate that the RFID device. Conversely, when the identifier does not match the RF fingerprint the RFID may be fraudulent and remedial action initiated to physically verify the RFID device and presents of the associated physical materials.

In another aspect the present invention involves a method of authenticating the identity of an RFID device having a tag identifier stored therein. The tag identifier for the RFID device is recorded along with an RF fingerprint for the RFID device. When the RFID device is interrogated a response is received from the interrogated RFID device. An RF fingerprint is determined form the response and the received response including the RF fingerprint associated with the response is compared to an expected RF fingerprint previously known to be associated with the RFID device being interrogated.

In another aspect the present invention involves a system for authenticating RFID devices each having a tag identifier stored therein. A data structure has a plurality of entries, where each entry is associated with a particular RFID device and holds the tag identifier for the associated RFID device along with an RF fingerprint for the associated RFID device. A reader/interrogator sends an interrogation signal to the RFID devices, wherein at least one of the plurality of RFID devices is configured to generate a response signal in response to the interrogation signal. A receiving component in the reader/interrogator receives the response from one of the interrogated RFID devices. A computational component in the reader/interrogator determines an RF fingerprint for the received response. A lookup mechanism coupled to the data structure uses information from the received response, such as an identifier stored in the RFID and included in the response, to retrieve an RF fingerprint associated with the RFID device. A comparator compares the RF fingerprint associated with the received response to the RF fingerprint recorded with the tag identifier of the RFID device to determine wither the RFID device is authentic.

### BRIEF DESCRIPTION OF THE DRAWINGS

FIG. 1 illustrates a system for authenticating an RFID device in accordance with an embodiment of the present invention;

FIG. 2 shows activities involved in determining an RF fingerprint for an RFID device in accordance with the present invention;

FIG. 3 shows activities involved in authenticating an RF fingerprint for an RFID device in accordance with the present invention;

FIG. 4 illustrates an exemplary data structure in accordance with an embodiment of the present invention; and

FIG. 5 illustrates, in block diagram form, an authentication unit in accordance with an implementation of the present invention.

### DETAILED DESCRIPTION OF THE PREFERRED EMBODIMENTS

The present invention is illustrated and described in terms of a system for authenticating RFID devices in which particular features of an RF signal from an RFID device are used to uniquely identify an RFID device. However, a number of other features of an RF signal may be used to uniquely identify the RFID device and the present invention is readily adapted to use these other features. Moreover, while the particular embodiments involve authenticating an RFID device, analogous techniques may be used by an RFID device to authenticate an interrogating device. Likewise, the present invention can be extended to implement bi-directional authentication wherein both the RFID device and the interrogator/reader each authenticate the devices with which they communicate. These and other variations of the specific teachings and examples provided herein are intended to be within the scope of the contemplated invention.

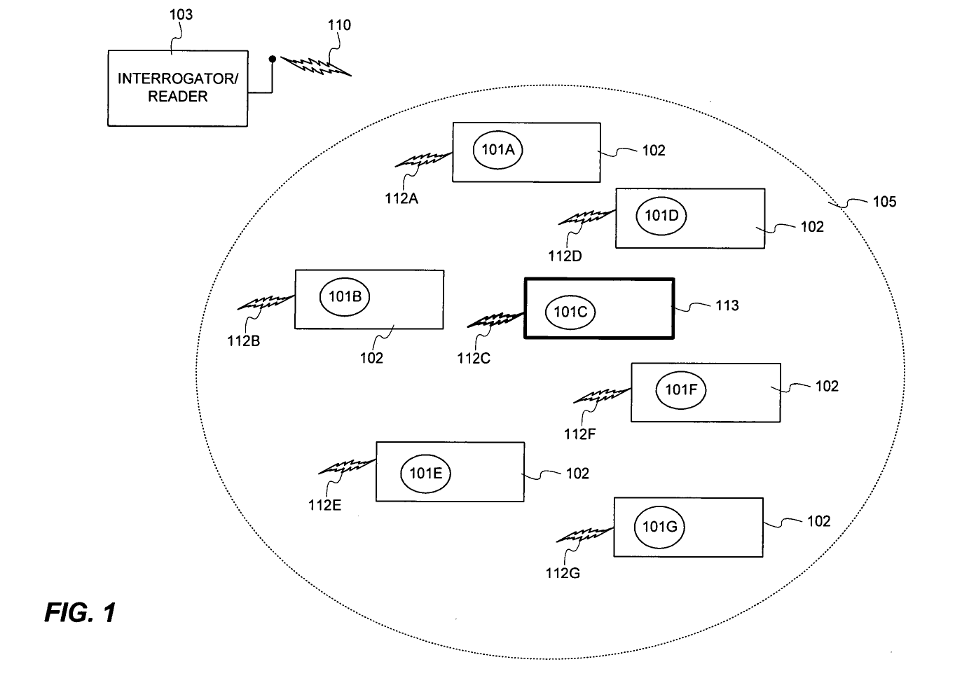

FIG. 1 shows an example environment in which the invention may be implemented. An interrogator/reader 103 communicates with an exemplary population 105 of RFID devices 102. Each RFID device 102 includes an identifier 101a-101g that identifies that RFID device 102. The identifier 101a-101g may be unique to the device 102. Alternatively, as might be used for an RFID price tag application, a number of RFID devices 102 may contain the same identifier 101a-101g. In practice any number of devices 101 may be included in population 105 and multiple interrogators/readers 103 may be used.

One or more interrogation signals 110 are transmitted from interrogator/reader 103 to the RFID devices 102. One or more response signals 112a-g are transmitted from RFID devices 102 to interrogator/reader 103. Significantly, each response signal 112a-g contains the identifier 101, sometimes referred to as the “tag ID”. Interrogator/reader 103 uses the identifier 101 to distinguish each RFID device from each other RFID device. Because RFID devices 1012 typically are not powered, response signals 112a-g may have a limited range of a few inches or meters.

According to the present invention, signals 110 and 112 are exchanged between interrogator/reader 103 and RFID devices 102 according to one or more interrogation protocols. An exemplary protocol is a binary traversal protocol described in U.S. Pat. 6,784,813 as well as alternative protocols described in U.S. Pat. No. 6,002,344 both of which are incorporated herein by reference in their entirety.

Interrogator/reader 103 receives the response signals 112 and extracts the identifier 101. Depending on the protocol employed for such communications, the retrieval of identifiers 101 from RFID devices 102 may involve the exchange of signals over multiple interrogation/response iterations. In other words, the receipt of a single identifier 101 may require interrogator/reader 103 to transmit multiple signals 110. In a corresponding manner, RFID devices 102 will respond with respective signals 112 upon the receipt of each interrogation signal 110, when a response is appropriate. Alternatively or in addition to identifications 101, interrogator/reader 103 may send other information to RFID devices 102. For example, interrogator/reader 103 may store information in one or more of RFID devices 102 to be retrieved at a later time. RFID devices 102 may include volatile or non-volatile memory for storing this information.

In FIG. 1, a fraudulent RFID device 113 is illustrated in bold. The fraudulent device 113 has been configured to contain a legitimate identifier 101c. In response to an interrogation signal 110, fraudulent device 113 will respond with one or more response signals 112c, also indicated in bold, that contain the legitimate identifier 101c. Prior systems could not readily detect this deceit so long as the signal 112c was substantially identical to a signal that would have been generated by a legitimate RFID device 102. Hence, by monitoring the output of a legitimate RFID device 102 and properly programming a fraudulent device 113 it was possible to cause the fraudulent device 113 to produce a legitimate response 112c even if the identifier 101c has been encrypted or otherwise protected. In accordance with the present invention, however, interrogator/reader 103 is configured to analyze not only the identifier 101, but also characteristics of the RF signal 112c itself to distinguish whether the RF signal 112c is transmitted by a legitimate RFID device 102 or from another source.

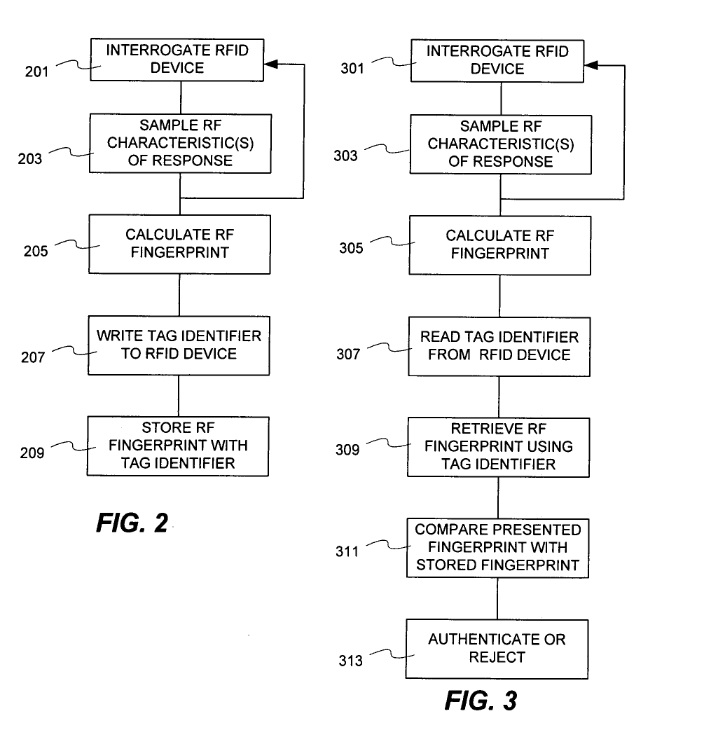

FIG. 2 shows activities involved in determining an RF fingerprint for an RFID device 102 in accordance with the present invention. Prior to deployment of an RFID device 102 the device is characterized to determine an RF fingerprint for that device 102. This characterization can occur in conjunction with the activities normally performed to program an RFID device 102. In this manner little additional time is added to the process of deploying a device 102.

In operation 201 an RFID device 102 is interrogated by transmitting an interrogation signal 110. RFID device 102 responds by transmitting a response signal 112. In 203 the RF response 112 is sampled and particular features of the RF response signal 112 are extracted. Useful features often occur at a transient portion of the RF response signal 112 that occurs when an RFID device 102 first begins to transmit. However, other portions of a response signal 112 will include unique information that can be used to develop an RF fingerprint as well. It is helpful to select features of response signal 112 that are strongly related to manufacturing variations of the RFID device 102 and that are not significantly affected by environmental characteristics of the interrogation/response environment. For example, a feature that is strongly affected by distance between the interrogator 103 and a device 102 is less useful.

Useful features include signal amplitude, phase and frequency. Any one of these features may be used to develop an RF fingerprint although a combination of two or all three of these features tends to produce a more repeatable and unique RF fingerprint. Also, these features can be measured at a particular point in time or at multiple points in time. Moreover, an RF fingerprint can be based on the value of these features and/or the rate of change in value of these features, and/or the standard deviation of these features over a plurality of measurements (or similar analysis) to meet the needs of a particular application. It is useful to repeat steps 201 and 203 a number of times and averaging or otherwise statistically combining the results to obtain a more representative value for the various measured features. The number of times that these steps are repeated in the order of 5-10, however, any number of repetitions may be used. In activity 205 an RF fingerprint value is calculated by arithmetically and/or statistically combining the measurements taken during sampling step 203.

In operation 207 a tag identifier 101 is written to a memory of device 102. Alternatively, if device 102 is already programmed with an identifier 101 it is read out if it is not already known. The RF fingerprint is stored in a data structure accessible to interrogator/reader 103 along with the tag identifier 101 in operation 209.

FIG. 3 shows activities involved in authenticating an RF fingerprint for an RFID device in accordance with the present invention. In operation 301 an RFID device 102 is interrogated by transmitting an interrogation signal 110. RFID device 102 responds by transmitting a response signal 112. In 303 the RF response 112 is sampled and particular features, the same features extracted in operation 203, of the RF response signal 112 are extracted. It is useful to repeat steps 301 and 303 a number of times and averaging or otherwise statistically combining the results to obtain a more representative value for the various measured features. The number of times that these steps are repeated in the order of 5-10, however, any number of repetitions may be used. In activity 305 an RF fingerprint value is calculated by arithmetically and/or statistically combining the measurements taken during sampling step 303 using the same algorithm employed in operation 205.

In operation 307 a tag identifier 101 is read out, which may require multiple interrogations. It is contemplated that reading the tag identifier 101 step 307 may occur simultaneously with operations 301/302 because the RF fingerprint can be extracted from the beginning portion of conventional responses 112. In operation 309, the RF fingerprint is retrieved from the data structure using the tag identifier 101 extracted in step 307. The retrieved RF fingerprint is compared to the RF fingerprint presented during operations 301-305 in operation 311. The comparison can be precise, but in most cases will be a “fuzzy” matching to account for normal variations that occur when reading features of an RF signal. In operation 313 the device is authenticated or rejected based on the comparison that is performed in operation 311.

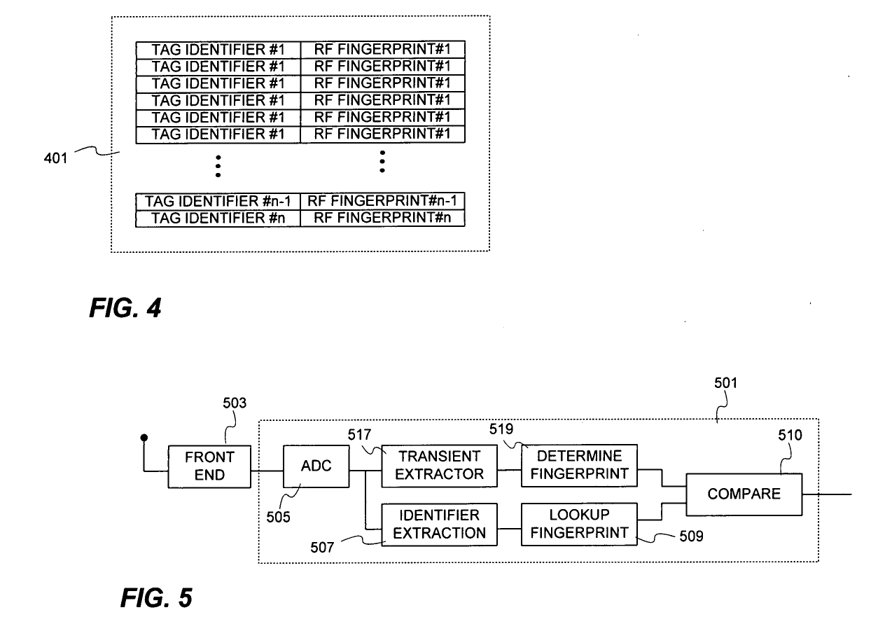

FIG. 4 illustrates an exemplary data structure 401 in accordance with an embodiment of the present invention. Data structure 401 is implemented within each interrogator/reader device 103 used in a system or may be implemented in a shared resource that is accessible to each interrogator/reader device 103 used in a system. In a simple form, data structure 401 includes a plurality of entries such that an entry corresponds to each RFID device 102 in population 105. In a typical application entries in data structure 401 will be updated as RFID devices 102 are added and removed from population 105. Each entry includes a tag identifier 101 that is stored in a particular RFID device 102 as well as an RF fingerprint for that particular RFID device. In some implementations data structure 401 is indexed by the tag identifier 101. However, it is contemplated that data structure 401 may also be indexed by the RF fingerprint value, although such implementations will require more sophisticated lookup mechanisms as the RF fingerprint value tends to be imprecise. However, mechanisms such as fuzzy matching and neural network techniques exist for searching imprecise indices as are used in searching human fingerprint databases, image databases and the like.

In operation, once a tag identifier 101 is read from a device 102 data structure 401 is accessed (e.g., in operation 309 shown in FIG. 3). The RF fingerprint for that device is returned from data structure 401. In applications in which the identifier 101 is not unique a plurality of RF fingerprints may be returned. Comparison operations (e.g., operation 311 in FIG. 3) are performed against the returned RF fingerprint(s) to determine whether the current RF fingerprint presented by the RFID device 102 matches an RF fingerprint stored in data structure 401.

FIG. 5 illustrates, in block diagram form, an authentication unit 501 in accordance with an implementation of the present invention. Authentication unit 501 is implemented within each interrogator/reader device 103 used in a system or in a shared resource that is accessible to each interrogator/reader device 103 used in a system. Front end 503 comprises electronics for receiving the response signal 112 and down-converting the RF signal to frequencies that are useful to authentication unit 501. The down converted signal is coupled to an analog-to-digital converter 505 which generates a serial or parallel digital output. Although signals with only real components can be used with RFF, in particular applications front end 503 generates a complex signal comprising an in-phase portion i(t) and a quadrature portion q(t). Using the complex signal may better preserve some characteristics of a received response signal 112, such as amplitude and phase information, which can enhance both the detection/extraction of features as well as determining an RF fingerprint from the detected features.

As is performed in conventional RFID techniques, the identifier 101 is extracted from the digitized signal by component 507. The identifier 101 is used by lookup unit 509 to access a data structure, such as data structure 401 shown in FIG. 4, which returns one or more RF fingerprints associated with that identifier 101. Also, the digitized output from the analog-to-digital converter 505 is used by transient extractor unit 517 to extract information about the RF response signal 112 itself. This information relates to, for example, the amplitude, phase, frequency, and similar characteristics of the RF response signal 1 12 that typically occur at a turn on transient portion of RF response signal 1 12. The information extracted by transient extractor 517 is applied to computational unit 517 which calculates an RF fingerprint, referred to as the “presented fingerprint” from the extracted information. Comparator 510 receives both the presented RF fingerprint and the retrieved RF fingerprint to determine whether a match exists, indicating an authentic RFID device 102.

The components shown in FIG. 5 may be implemented by hardware, firmware, software, as well as hybrid systems comprising hardware firmware and/or software. Comparator 5 10, for example, may be implemented in digital comparison logic, fuzzy logic, neural networks, or other available technology. Additional components may be combined with those shown in FIG. 5 to meet the needs of particular applications. For example, digital and/or analog filters, equalization circuits, and the like may be added to affect performance in particular environments.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. A method of authenticating the identity of an RFID device comprising the steps of:
providing an RFID device having a tag identifier stored therein;
recording the tag identifier for the RFID device along with an RF fingerprint for the RFID device;
interrogating an RFID device;
receiving a response from the interrogated RFID device;
determining an RF fingerprint for the received response; and
comparing the RF fingerprint associated with the received response to the RF fingerprint recorded with the tag identifier of the RFID device.

2. The method of claim 1 wherein the RF fingerprint is based on an amplitude component of a turn-on transient produced by the RFID device.

3. The method of claim 1 wherein the RF fingerprint is based on a phase component of a turn-on transient produced by the RFID device.

4. The method of claim 1 wherein the RF fingerprint is based on a frequency component of a turn-on transient produced by the RFID device.

5. An RFID price tag implementing the method of claim 1.

6. The method of claim 1 further comprising:
determining the RF fingerprint by sequentially interrogating the RFID device a plurality of times, sampling the RF characteristics of the response signal from the RFID device; analyzing the response signal to identify at least one unique characteristic of the RF response; and calculating an RF fingerprint using the at least one characteristic.

7. The method of claim 1 further comprising maintaining a table storing the tag identifier for each of a plurality of RFID devices in association with an RF fingerprint for the RFID device.

8. The method of claim 1, wherein the RFID device comprises a passive, unpowered circuit that transmits a unique ID in response to an interrogation signal.

9. A system for authenticating RFID devices comprising:
a plurality of RFID devices, each having a tag identifier stored therein;
a data structure having a plurality of entries, wherein each entry is associated with a particular RFID device and holds the tag identifier for the associated RFID device along with an RF fingerprint for the associated RFID device;
a reader/interrogator operable to send an interrogation signal to the RFID devices, wherein at least one of the plurality of RFID devices is configured to generate a response signal in response to the interrogation signal;
a receiving component in the reader/interrogator operable to receive the response from one of the interrogated RFID devices;
a computational component in the reader/interrogator that is operable to determine an RF fingerprint for the received response; and
a lookup mechanism coupled to the data structure and operable to use information from the received response to retrieve an RF fingerprint associated with the RFID device; and
a comparator comparing the RF fingerprint associated with the received response to the RF fingerprint recorded with the tag identifier of the RFID device.

10. The system of claim 9 wherein the RF fingerprint stored in the data structure for a particular RFID device is determined by sequentially interrogating the RFID device a plurality of times, sampling the RF characteristics of the response signal from the RFID device; analyzing the response signal to identify at least one unique characteristic of the RF response; and calculating an RF fingerprint using the at least one characteristic.

11. The system of claim 9 wherein the RF fingerprint is based on an amplitude component of a turn-on transient produced by the RFID device.

12. The system of claim 9 wherein the RF fingerprint is based on a phase component of a turn-on transient produced by the RFID device.

13. The system of claim 9 wherein the RF fingerprint is based on a frequency component of a turn-on transient produced by the RFID device.

14. The system of claim 9 wherein the data structure is indexed by an identifier encoded in the RFID device, wherein the identifier is included in the response signal generated by the RFID device.

15. A data structure implemented in a physical memory device for use in an RFID authentication system, the data structure comprising:
a plurality of entries, wherein each entry is associated with a particular RFID device;
an identifier value stored in each entry, wherein the identifier is the same as an identifier stored in the associated RFID device; and
an RF fingerprint stored in each entry, wherein the RF fingerprint has been determined from RF characteristics of the associated RFID device.

16. The data structure of claim 15 wherein the data structure is indexed by the identifier values.

17. The data structure of claim 15 further comprising an interface for receiving requests that identify a particular identifier value, initiating a lookup in the table to identify one or more entries associated with the particular identifier value, and returning one or more RF fingerprints from the identified one or more entries.
